(19) United States
(12) Patent Application Publication
(10) Pub. No.: US 2022/0309840 A1
(43) Pub. Date: Sep. 29, 2022

(54) SYSTEM AND METHOD FOR RECONSTRUCTING HIGH FREQUENCY SIGNALS FROM LOW FREQUENCY VERSIONS THEREOF

(71) Applicant: Bridgestone Americas Tire Operations, LLC, Nashville, TN (US)

(72) Inventors: Thomas Anthony Sams, Hartville, OH (US); Ramy Hanna, Copley, OH (US)

(21) Appl. No.: 17/702,956

(22) Filed: Mar. 24, 2022

Related U.S. Application Data
(60) Provisional application No. 63/165,410, filed on Mar. 24, 2021.

(51) Int. Cl. G07C 5/00; B60C 11/24

(52) U.S. Cl. CPC G07C 5/008; B60C 11/246

(57) ABSTRACT

Systems and methods are disclosed herein for estimating or predicting operating conditions/states (e.g., tire wear) based on signal reconstruction from low frequency data sources. A processor periodically receives signals generated from a monitoring device at a first (lower) sampling rate, and further determines a reference signal representing one cycle of the generated signals, and a period of the received signals based on analysis across multiple cycles of generated signals, wherein the period is not an integer multiple of the first sampling rate. A curve is constructed corresponding to signals generated from the monitoring device at a second (higher) sampling rate, at least by correlating multiple cycles of signals at the first sampling rate and the reference signal. Current conditions/states are estimated, substantially in real time, based at least in part on the constructed curve, and an output signal is selectively generated based on the estimated current conditions/states.

### CROSS-REFERENCES TO RELATED APPLICATIONS

This application claims benefit of U.S. Provisional Patent Application No. 63/165,410, filed Mar. 24, 2021, and which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE DISCLOSURE

The present disclosure relates generally to techniques for reconstructing high frequency versions of signals from sources producing low frequency signals.

More particularly, systems, methods, and related algorithms as disclosed herein may implement such techniques for improved estimating of conditions and/or states, such as for example vehicle tire and/or roadway conditions or states.

### BACKGROUND

Sensors such as accelerometers can be attached to tires to measure physical quantities (e.g., radial acceleration) which enable the estimation of condition of a tire (e.g., tread depth, load, speed, etc.) or roadway (e.g., condition, friction, etc.). The most relevant information regarding tire condition is collected from, or at the leading and/or trailing edges of, the footprint (contact patch) of the tire with respect to the road surface, a relatively small portion of the overall circumference of the tire. Accordingly, a high sampling rate is desired to provide the highest resolution possible, leading to a better estimate of the tire/roadway condition.

However, sometimes it is difficult to obtain a high sampling rate for a periodic signal. For example, this signal can be the output of a sensor which might not be able provide a high sampling rate signal. In many cases, a lower frequency data collection or transmission rate may be preferred for cost savings or their relatively lower complexity.

Since it is difficult to obtain a high frequency compensated acceleration measurement, for example where the g-value is directly obtained from an accelerometer, it would be desirable to provide the same number of samples using lower sampling rate accelerometers.

It would further be desirable to provide the benefit of such a system and method for any periodic signal, accordingly to construct a high sampling rate signal from multiple periods of lower sampling rate version of the same signal as long as the signal period is not equal to an integer multiple of the sampling rate period.

### BRIEF SUMMARY

For a tire rolling on a flat pavement at a constant speed, the radial acceleration component will be periodic with a period equal to the time of one full rotation. Therefore, if the time of one full tire rotation is not an integer multiple of the sampling time, a method as disclosed herein may be provided to reconstruct a higher sampling rate of acceleration measurements using a slower sampling rate accelerometer by combining multiple low sampling rate cycles into one higher sampling rate cycle.

The ability to use lower sampling frequency accelerometers while achieving similar performance to those with higher sampling rates, may provide numerous conceivable advantages including but not limited to: broader range of data sources; cost savings attributable to lower sampling frequency accelerometers; improvements in the perceived performance of high frequency accelerometers to better estimate load and wear; and the like.

An exemplary embodiment of a system as disclosed herein for estimating or predicting operating conditions and/or states based on signal reconstruction from low frequency data sources comprises a monitoring device configured to generate signals at a first sampling rate, wherein each of the generated signals are representative of a measured value, and a processor functionally linked to the monitoring device via a communications network. The processor is configured to execute program instructions residing on a non-transitory machine-readable medium and thereby directing performance of at least the following operations. The processor periodically receives the signals generated from the monitoring device at the first sampling rate, determines a reference signal representing one cycle of the generated signals, and determines a period of the received signals based on analysis across multiple cycles of the generated signals. As long as the period is not an integer multiple of the first sampling rate, the processor further constructs a curve corresponding to signals generated from the monitoring device at a second sampling rate higher than the first sampling rate, at least by correlating multiple cycles of signals at the first sampling rate and the reference signal, estimates one or more current conditions or states, substantially in real time, based at least in part on the constructed curve, and selectively generates an output signal based on the estimated one or more current conditions or states.

In one exemplary aspect with respect to the above-referenced embodiment, the period of the received signals may be determined via a frequency domain conversion for multiple cycles thereof. For example, the frequency domain conversion may be provided via Fast Fourier Transformation of the multiple cycles of the received signals.

In another exemplary aspect with respect to the above-referenced embodiment, the reference signal may be empirically determined by averaging the received signals across multiple periods.

In another exemplary aspect with respect to the above-referenced embodiment, the reference signal may be selectively retrieved from data storage as a predetermined custom wavelet representing one cycle of the received signals.

In another exemplary aspect with respect to the above-referenced embodiment, the second sampling rate associated with the constructed signal may be dynamically increased by a factor corresponding to a number of cycles used.

In another exemplary aspect with respect to the above-referenced embodiment, the monitoring device may comprise a sensor mounted on a tire of a vehicle, wherein each cycle corresponds to one revolution of the tire.

In another exemplary aspect with respect to the above-referenced embodiment, the signals generated by the tire-mounted sensor may be representative of measured acceleration values.

In another exemplary aspect with respect to the above-referenced embodiment, the estimated one or more conditions or states may be implemented as inputs to a tire wear prediction model.

In another exemplary aspect with respect to the above-referenced embodiment, the processor may be further configured to predict a replacement time for the tire, based on a predicted tire wear status, as compared with a tire wear threshold associated with the tire. A vehicle maintenance alert may be generated comprising the predicted replacement time and an identifier associated with the tire, wherein a message comprising the vehicle maintenance alert is transmitted to a fleet management device.

The processor and the aforementioned operations may be associated with a computing device residing within the vehicle. Alternatively, such a computing device may be remote with respect to the vehicle and functionally linked to the one or more sensors via a communications network and at least a second computing device residing within the vehicle. Still further alternatively, the various operations may be executed via distributed logic residing in one or more computing devices residing within the vehicle and/or remotely arranged.

### BRIEF DESCRIPTION OF THE SEVERAL VIEWS OF THE DRAWINGS

Hereinafter, embodiments of the invention are illustrated in more detail with reference to the drawings.

FIG. 1 is a block diagram representing an exemplary embodiment of a system as disclosed herein.

FIG. 2 is a flowchart representing an exemplary embodiment of a method as disclosed herein.

FIG. 3 is a graphical diagram representing an exemplary down-sampled acceleration signal for one rotation at 500 Hz of a tire rolling on a drum at 120 kilometers per hour (kph).

FIG. 4 is a graphical diagram representing exemplary collected signals across multiple rotations of the tire from FIG. 3 and at the same speed.

FIG. 5 is a graphical diagram representing an exemplary reconstructed high frequency signal curve based on multiple low frequency samples.

### DETAILED DESCRIPTION

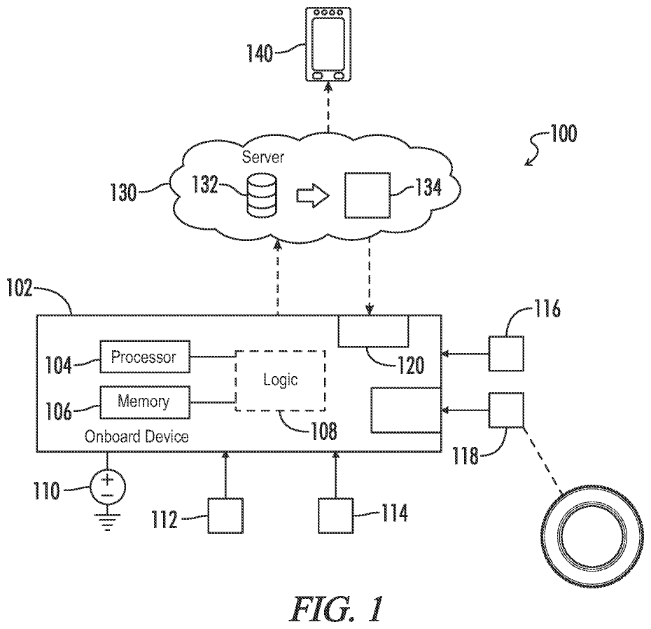

Referring generally to FIGS. 1-5, various exemplary embodiments of an invention may now be described in detail. Where the various figures may describe embodiments sharing various common elements and features with other embodiments, similar elements and features are given the same reference numerals and redundant description thereof may be omitted below.

Various embodiments of a system as disclosed herein may include centralized computing nodes (e.g., a cloud server) in functional communication with a plurality of distributed data collectors and computing nodes for effectively implementing algorithms as disclosed herein. Generally stated, such distributed data collectors may only be capable of producing signals at a low frequency sampling rate, whereas a higher frequency sampling rate is desirable for effective data analysis at the centralized computing nodes. The low frequency sampling rate associated with the data collection stage may be due to the capabilities of the distributed data collectors, a communications network (i.e., data transmission stage), data storage capabilities, or any one or more of the same within the scope of the present disclosure.

In a particular embodiment as disclosed in more detail below, the system is provided for data collection from one or more vehicle-mounted data sources with low frequency sampling rates, wherein vehicle-related conditions and/or states such as for example tire wear can be estimated based on reconstructed high frequency sampling rates. However, the scope of the present disclosure is not expressly limited to vehicle applications unless otherwise stated herein, and the algorithms may be applied in other fields of use as contemplated by one of skill in the relevant art.

Referring now to FIG. 1, an exemplary embodiment of the system 100 includes a computing device 102 that is onboard a vehicle and configured to at least obtain data and transmit said data to a remote server 130 and/or perform relevant computations as disclosed herein. The computing device 102 may be portable or otherwise modular as part of a distributed vehicle data collection and control system (as shown), or otherwise may be integrally provided with respect to a central vehicle data collection and control system (not shown). The computing device 102 may include a processor 104 and memory 106 having program logic 108 residing thereon. The computing device 102 in various embodiments may be part of a vehicle electronic control unit (ECU) or otherwise may be discrete in nature, for example permanently or detachably provided with respect to a vehicle mount.

Generally stated, a system 100 as disclosed herein may implement numerous components distributed across one or more vehicles, for example but not necessarily associated with a fleet management entity, and further a central server 130 or server network in functional communication with each of the vehicles via a communications network. The vehicle components may typically include one or more sensors such as, e.g., vehicle body accelerometers, gyroscopes, inertial measurement units (IMU), position sensors such as global positioning system (GPS) transponders 112, tire pressure monitoring system (TPMS) sensor transmitters 118 and associated onboard receivers, or the like, as linked for example to a controller area network (CAN) bus network and providing signals thereby to local processing units. The illustrated embodiment includes for illustrative purposes, without otherwise limiting the scope of the present invention thereby, an ambient temperature sensor 116, a vehicle speed sensor 114 configured to collect for example acceleration data associated with the vehicle, and a DC power source 110. One or more of the sensors as disclosed herein may be integrated or otherwise collectively located in a given modular structure as opposed to being discrete and decentralized in structure. For example, a tire-mounted TPMS sensor as referred to herein may be configured to generate output signals corresponding to each of a plurality of tire-specific conditions (e.g., acceleration, pressure, temperature).

Various bus interfaces, protocols, and associated networks are well known in the art for the communication between the respective data source and the local computing device, and one of skill in the art would recognize a wide range of such tools and means for implementing the same.

It should be noted that the embodiment represented in FIG. 1 is not limiting on the scope of a system or method as disclosed herein, and that in alternative embodiments one or more of the algorithms/models 134 may be implemented locally at the onboard computing device 102 rather than at the server level. For example, algorithms/models 134 may be generated and trained over time at the server level and downloaded to the onboard computing device 102 for local execution of one or more steps or operations as disclosed herein.

In other alternative embodiments, one or more of the various sensors 112, 114, 116, 118 may be configured to communicate directly with the remote server 130, or via a mobile computing device (not shown) carried by a user of the vehicle, rather than via the onboard computing device 102.

The system 100 may include additional distributed program logic such as for example residing on a fleet management server or other user computing device 140, or a user interface of a device resident to the vehicle or associated with a driver thereof (not shown) for real-time notifications (e.g., via a visual and/or audio indicator), with the fleet management device in some embodiments being functionally linked to the onboard device 102 via a communications network. System programming information may for example be provided on-board by the driver or from a fleet manager.

Vehicle and tire sensors 112, 114, 116, 118 may in an embodiment further be provided with unique identifiers, wherein the onboard device processor 104 can distinguish between signals provided from respective sensors on the same vehicle, and further in certain embodiments wherein a central server 130 and/or fleet maintenance supervisor client device 140 may distinguish between signals provided from tires 101 and associated vehicle and/or tire sensors across a plurality of vehicles. In other words, sensor output values may in various embodiments be associated with a particular tire 101, a particular vehicle, and/or a particular tire-vehicle system for the purposes of onboard or remote/downstream data storage and implementation for calculations as disclosed herein. The onboard device processor 104 may communicate directly with the hosted server 130 as shown in FIG. 1, or alternatively the driver's mobile device or truck-mounted computing device may be configured to receive and process/transmit onboard device output data to the hosted server 130 and/or fleet management server/device 140.

Signals received from a particular vehicle and/or tire sensor 112, 114, 116, 118 may be stored in onboard device memory 106, or an equivalent data storage network functionally linked to the onboard device processor 104, for selective retrieval as needed for calculations according to the method disclosed herein. A “data storage network” as used herein may refer generally to individual, centralized, or distributed logical and/or physical entities configured to store data and enable selective retrieval of data therefrom, and may include for example but without limitation a memory, look-up tables, files, registers, databases, and the like. In some embodiments, raw data signals from the various sensors 112, 114, 116, 118 may be communicated substantially in real time from the vehicle to the server 130. Alternatively, particularly in view of the inherent inefficiencies in continuous data transmission of high frequency data, the data may for example be compiled, encoded, and/or summarized for more efficient (e.g., periodic time-based or alternatively defined event-based) transmission from the vehicle to the remote server 130 via an appropriate communications network.

The vehicle data and/or tire data, once transmitted via a communications network to the hosted server 130, may be stored for example in a database 132 associated therewith. The server 130 may include or otherwise be associated with one or more algorithmic models 134 as disclosed herein for selectively retrieving and processing the vehicle data and/or tire data as appropriate inputs. The algorithms 134 may be implemented at least in part via execution of a processor, enabling selective retrieval of the vehicle data and/or tire data and further in electronic communication for the input of any additional data or algorithms from a database, lookup table, or the like that is stored in association with the server 130.

The system 100 may include additional distributed program logic such as for example residing on a fleet management server or other user computing device 140, or a user interface of a device resident to the vehicle or associated with a driver thereof (not shown) for real-time notifications (e.g., via a visual and/or audio indicator), with the fleet management device 140 in some embodiments being functionally linked to the onboard device 102 via a communications network. System programming information may for example be provided on-board by the driver or from a fleet manager.

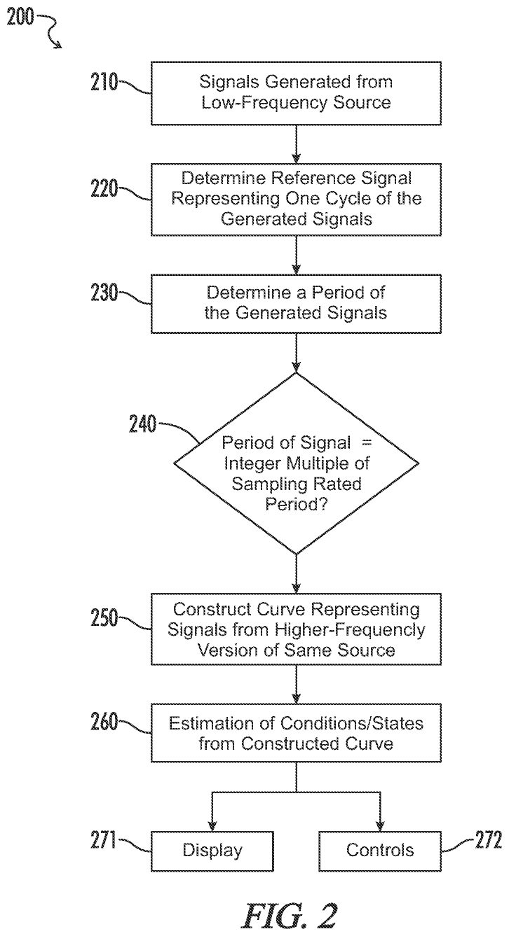

Referring now to FIG. 2, an exemplary method of operation 200 may now be disclosed, for example as implemented by the above-referenced system embodiment 100. The steps associated with method 200 are exemplary in nature, and one of skill in the art may appreciate that certain steps may be performed in different order or even omitted entirely unless otherwise specifically stated.

In step 210, signals are produced at a first sampling rate from a data source. As noted above, low frequency signals may be provided for implementation by algorithms as disclosed herein in some embodiments based on the limitations of the data collection units (e.g., sensors), but in some embodiments the low frequency signals may result at least in part from limitations in local data storage or transmission with respect to a remote computing device.

In step 220, a reference signal is determined or otherwise obtained as representing one cycle of the generated low frequency signals (i.e., signals at a first sampling rate). In step 230, the method 200 further includes determining a period of the generated signals. In an embodiment, the period may be obtained by identifying relevant time-based and/or frequency-based characteristics of the signals, for example via performing a Fast Fourier Transform (FFT) of multiple cycles (e.g., N=12) of the signal. The reference signal may for example be obtained by averaging out the multiple periods of the generated signals (e.g., corresponding to measured values of radial acceleration), by designing a custom wavelet that represents one cycle of the signal, or the like.

As long as the signal period is not equal to an integer multiple of the sampling rate period (i.e., “yes” in response to the query in step 240), the method 200 may continue in step 250 with construction of a high sampling rate signal from multiple periods of the lower sampling rate version of the same signal. In an embodiment, a cross correlation function (e.g. xcorr(x,y) in MATLAB) may be implemented between multiple full cycles of the low sampling frequency signal and the reference signal representing one cycle of the signal. The cross-correlation function in this example peaks when the reference signal is aligned with the actual signal.

Using the cross-correlation function, the delays (lags) of the samples of subsequent cycles relative to the first period of the signal can be obtained and the samples can be arranged to obtain the signal representation of a higher sampling rate signal. Depending on the number of cycles, the sampling frequency of the reconstructed signal may be increased by a factor equals to the number of cycles used.

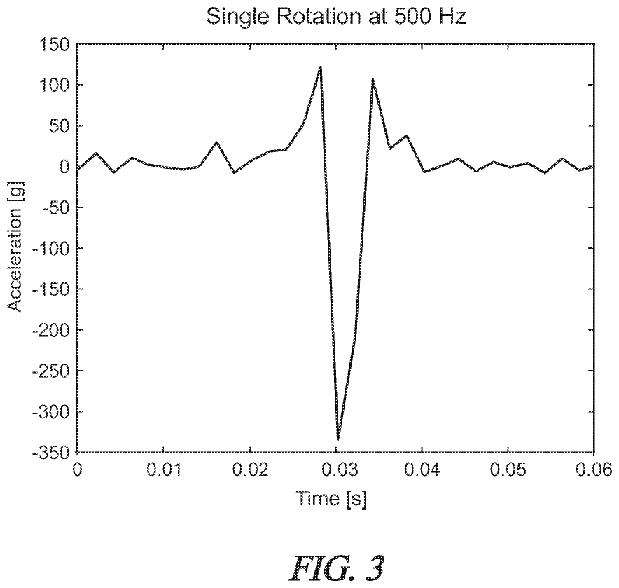

FIG. 3 provides an example of a down-sampled acceleration signal for an entire rotation at 500 Hz for a tire rolling on a drum at 120 kph. As one of skill in the art may appreciate, the resolution is relatively poor for higher speeds where the rotational velocity is high, and in this example only four points were collected in the footprint, also referred to as the contact patch (the region in the middle of the rotation corresponding to the rise-dip-rise sequence). It is in this footprint region that the most vital information is obtained.

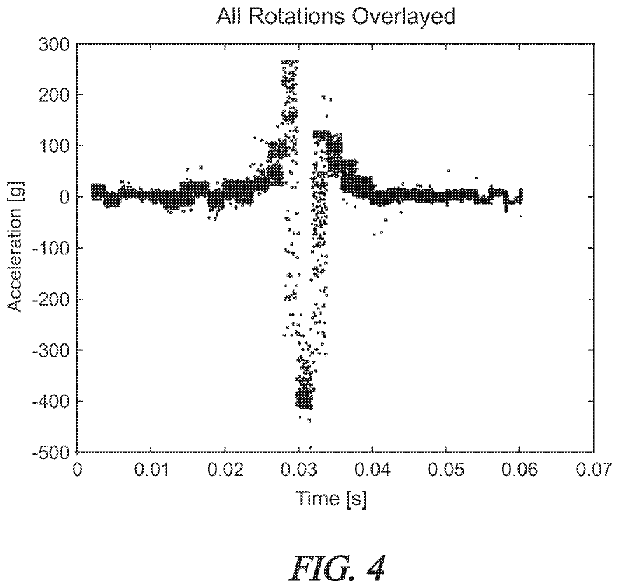

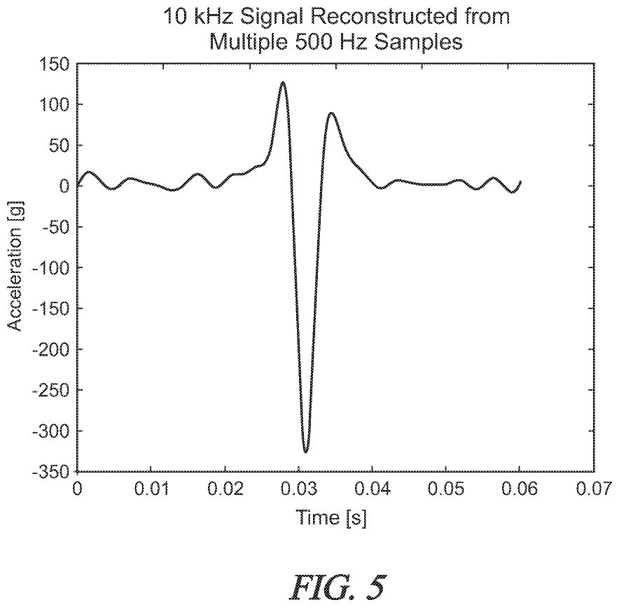

By collecting many rotations at the same speed, a more defined curve can begin to be seen, as represented for example in FIG. 4. Finally, an average curve can be found from this data, as further shown in FIG. 5. This curve closely matches the 20 kHz signal that was originally down-sampled.

In step 260, the method 200 may continue with estimation of one or more conditions and/or states from the constructed curve. In an embodiment associated with tire-mounted sensors such as accelerometers as the low sampling rate signal sources (i.e., low frequency data collection stage), the systems and methods as disclosed herein may be implemented to estimate a condition of the tire (e.g., tread depth, load, speed, etc.) or roadway (e.g., condition, friction, etc.). The higher sampling rate provides the highest resolution possible, leading to a better estimate of the tire/roadway condition.

As further described in various examples below, output signals from the system 100 based on the estimated conditions and/or states from the constructed curve may be provided to a user interface for selective display/alerts (step 271) or as automated control signals or triggers therefor (step 272).

In an embodiment, the tread depth estimations as inputs to a model for predicting wear values at one or more future points in time, wherein such predicted values may be compared to respective threshold values. For example, a feedback signal corresponding to the predicted tire wear status (e.g., predicted tread depth at a given distance, time, or the like) may be provided via an interface to an onboard device 102 associated with the vehicle itself, or to a mobile device associated with a user, such as for example integrating with a user interface configured to provide alerts or notice/recommendations that a tire should or soon will need to be replaced. Other tire-related threshold events can be predicted and implemented for alerts and/or interventions within the scope of the present disclosure and based on predicted tire wear, including for example tire rotation, alignment, inflation, and the like. The system 100 may generate such alerts and/or intervention recommendations based on individual thresholds, groups of thresholds, and/or non-threshold algorithmic comparisons with respect to predetermined parameters.

Various tire wear values may be estimated based on, e.g., “digital twin” virtual representations of various physical parts, processes or systems wherein digital and physical data is paired and combined with learning systems such as for example neural networks. For example, high sampling rate data as disclosed herein from a vehicle and associated location/route information may be provided to generate a digital representation of the vehicle tire for estimation of tire wear, wherein subsequent comparison of the estimated tire wear with a determined actual tire wear may be implemented as feedback for the machine learning algorithms. The wear model may be implemented at the vehicle, for processing via the onboard system, or the tire data and/or vehicle data may be processed to provide representative data to the hosted server for remote wear estimation.

The tire wear status (e.g., tread depth) may for example be provided along with certain vehicle data as inputs to a traction model (step 350), which may be configured to provide an estimated traction status or one or more traction characteristics for the respective tire. As with the aforementioned wear model, the traction model may comprise “digital twin” virtual representations of physical parts, processes or systems wherein digital and physical data are paired and combined with learning systems such as for example artificial neural networks. Real vehicle data and/or tire data from a particular tire, vehicle or tire-vehicle system may be provided throughout the life cycle of the respective asset to generate a virtual representation of the vehicle tire for estimation of tire traction, wherein subsequent comparison of the estimated tire traction with a corresponding measured or determined actual tire traction may preferably be implemented as feedback for machine learning algorithms executed at the server level.

The traction model may in various embodiments utilize the results from prior testing, including for example stopping distance testing results, tire traction testing results, etc., as collected with respect to numerous tire-vehicle systems and associated combinations of values for input parameters (e.g., tire tread, inflation pressure, road surface characteristics, vehicle speed and acceleration, slip rate and angle, normal force, braking pressure and load), wherein a tire traction output may be effectively predicted for a given set of current vehicle data and tire data inputs.

In one embodiment, outputs from this traction model may be incorporated into an active safety system. The term “active safety systems” as used herein may preferably encompass such systems as are generally known to one of skill in the art, including but not limited to examples such as collision avoidance systems, advanced driver-assistance systems (ADAS), anti-lock braking systems (ABS), etc., which can be configured to utilize the traction model output information to achieve optimal performance. For example, collision avoidance systems are typically configured to take evasive action, such as automatically engaging the brakes of a host vehicle to avoid or mitigate a potential collision with a target vehicle, and enhanced information regarding the traction capabilities of the tires and accordingly the braking capabilities of the tire-vehicle system are eminently desirable.

In another embodiment, a ride-sharing autonomous fleet could use output data from the traction model to disable or otherwise selectively remove vehicles with low tread depth from use during inclement weather, or potentially to limit their maximum speeds.

In various embodiments, the method may further involve comparing a current wear value with respect to a threshold value to determine whether (or when) the tire requires intervention such as for example replacement. The method may alternatively or further include predicting wear values at one or more future points in time, wherein such predicted values may be compared to respective threshold values. As represented for example in FIG. 1, a feedback signal corresponding to the predicted tire wear status (e.g., predicted tread depth at a given distance, time, or the like) may be provided via an interface 120 to an onboard device 102 associated with the vehicle itself, or to a mobile device 140 associated with a user, such as for example integrating with a user interface configured to provide alerts or notice/recommendations that a tire should or soon will need to be replaced.

As another example, an autonomous vehicle fleet may comprise numerous vehicles having varying minimum tread status values, wherein the fleet management system may be configured to disable deployment of vehicles falling below a minimum threshold. The fleet management system may further implement varying minimum tread status values corresponding to wheel positions. The system may accordingly be configured to act upon a minimum tire tread value for each of a plurality of tires associated with a vehicle, or in an embodiment may calculate an aggregated tread status for the plurality of tires for comparison against a minimum threshold.

In various embodiments the method may further include data streaming even where threshold violations are not detected, wherein estimated and/or predicted wear values can be displayed in real-time on the local user interface and/or a remote display (e.g., associated with the fleet management server), and further displayed data may include, e.g., the contained air temperature.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Whereas certain embodiments of the present invention may typically be described herein with respect to tire wear estimation for fleet management systems and more particularly for autonomous vehicle fleets or commercial trucking applications, the invention is in no way expressly limited thereto and the term “vehicle” as used herein unless otherwise stated may refer to an automobile, truck, or any equivalent thereof, whether self-propelled or otherwise, as may include one or more tires and therefore require accurate estimation or prediction of tire wear and potential disabling, replacement, or intervention in the form of for example direct vehicle control adjustments.

The term “user” as used herein unless otherwise stated may refer to a driver, passenger, mechanic, technician, fleet management personnel, or any other person or entity as may be, e.g., associated with a device having a user interface for providing features and steps as disclosed herein.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A system for estimating or predicting operating conditions and/or states based on signal reconstruction from low frequency data sources, the system comprising:
a monitoring device comprising at least one sensor configured to generate signals at a first sampling rate, wherein each of the generated signals are representative of a measured value;
a processor functionally linked to the monitoring device via a communications network, wherein the processor is configured to execute program instructions residing on a non-transitory machine-readable medium and thereby directing performance of operations comprising:
periodically receiving the signals generated from the monitoring device at the first sampling rate;
determining a reference signal representing one cycle of the generated signals;
determining a period of the received signals based on analysis across multiple cycles of the generated signals, wherein the period is not an integer multiple of the first sampling rate;
constructing a curve corresponding to signals generated from the monitoring device at a second sampling rate higher than the first sampling rate, at least by correlating multiple cycles of signals at the first sampling rate and the reference signal;
estimating one or more current conditions or states, substantially in real time, based at least in part on the constructed curve; and
selectively generating an output signal based on the estimated one or more current conditions or states.

2. The system of claim 1, wherein the period of the received signals is determined via a frequency domain conversion for multiple cycles thereof.

3. The system of claim 2, wherein the frequency domain conversion is provided via Fast Fourier Transformation of the multiple cycles of the received signals.

4. The system of claim 1, wherein the reference signal is empirically determined by averaging the received signals across multiple periods.

5. The system of claim 1, wherein the reference signal is selectively retrieved from data storage as a predetermined custom wavelet representing one cycle of the received signals.

6. The system of claim 1, wherein the second sampling rate associated with the constructed signal is dynamically increased by a factor corresponding to a number of cycles used.

7. The system of claim 1, as applied for estimating or predicting vehicle and/or tire operating conditions and/or states, wherein the monitoring device comprises at least one sensor mounted on a tire of a vehicle.

8. The system of claim 7, wherein each cycle corresponds to one revolution of the tire upon which the sensor is mounted.

9. The system of claim 8, wherein the signals generated by the tire-mounted sensor are representative of measured acceleration values.

10. The system of claim 8, wherein the estimated one or more conditions or states are implemented as inputs to a tire wear prediction model.

11. The system of claim 10, wherein the processor is further configured to:
predict a replacement time for the tire, based on a predicted tire wear status, as compared with a tire wear threshold associated with the tire;
generate a vehicle maintenance alert comprising the predicted replacement time and an identifier associated with the tire; and
transmit a message comprising the vehicle maintenance alert to a fleet management device.

12. A method for estimating or predicting operating conditions and/or states based on signal reconstruction from low frequency data sources, the method comprising:
periodically receiving signals generated from a monitoring device at a first sampling rate;
determining a reference signal representing one cycle of the generated signals;
determining a period of the received signals based on analysis across multiple cycles of the generated signals, wherein the period is not an integer multiple of the first sampling rate;
constructing a curve representing signals generated from the monitoring device at a second sampling rate higher than the first sampling rate, at least by correlating multiple cycles of signals at the first sampling rate and the reference signal;
estimating one or more current conditions or states, substantially in real time, based at least in part on the constructed curve; and
selectively generating an output signal based on the estimated one or more current conditions or states.

13. The method of claim 12, wherein the period of the received signals is determined via a frequency domain conversion for multiple cycles thereof.

14. The method of claim 13, wherein the frequency domain conversion is provided via Fast Fourier Transformation of the multiple cycles of the received signals.

15. The method of claim 12, wherein the reference signal is empirically determined by averaging the received signals across multiple periods.

16. The method of claim 12, wherein the reference signal is selectively retrieved from data storage as a predetermined custom wavelet representing one cycle of the received signals.

17. The method of claim 12, wherein the second sampling rate associated with the constructed signal is dynamically increased by a factor corresponding to a number of cycles used.

18. The method of claim 12, as applied for estimating or predicting vehicle and/or tire operating conditions and/or states, wherein the monitoring device comprises at least one sensor mounted on a tire of a vehicle and wherein each cycle corresponds to one revolution of the tire upon which the at least one sensor is mounted.

19. The method of claim 18, wherein the signals generated by the tire-mounted sensor are representative of measured acceleration values.

20. The method of claim 18, further comprising:
implementing the one or more current conditions or states as inputs to a tire wear prediction model;
predicting a replacement time for the tire, based on a predicted tire wear status, as compared with a tire wear threshold associated with the tire;
generating a vehicle maintenance alert comprising the predicted replacement time and an identifier associated with the tire; and
transmitting a message comprising the vehicle maintenance alert to a fleet management device.
